(19) United States
(12) Patent Application Publication
(10) Pub. No.: US 2010/0282825 A1
(43) Pub. Date: Nov. 11, 2010

(54) INTEGRAL MAGNETIC POSTCARD

(76) Inventor: Xiaoming Wang, Guangzhou City (CN)

Correspondence Address: Altera Law Group, LLC, 220 S 6 St Suite 1700, Minneapolis, MN, 55402, US

(21) Appl. No.: 12/810,572

(22) PCT Filed: Jul. 30, 2008
(86) PCT No.: PCT/CN2008/071810

§ 371 Date: Jul. 27, 2010

(30) Foreign Application Priority Data
Apr. 24, 2008 (CN) 200820046826.1

(51) Int. Cl. B42D 15/02

(52) U.S. Cl. 229/92.8

(57) ABSTRACT

The present invention introduces an integrated mag-postcard including a pattern layer as front side, a magnet layer as middle side and a mailing information layer as back side, wherein all three layers are integrated tightly. The integrated mag-postcard has full magnetic effect and ability of sticking on metal surface evenly and freely for a long time without bending or wrinkle. The appearance of present invention is substantially the same as a conventional postcard. Both the pattern layer and the mailing information layer may be readable, printable or writable freely and easily. Furthermore, the magnetic property of present invention still remains after being posted to anywhere in the world.

### BACKGROUND OF THE INVENTION

1. Field of the Invention

The present invention relates to a postcard, especially an integrated mag-postcard.

2. Description of the Prior Art

The postcard is globally popular used as a post choice to express interpersonal feeling in daily life. The conventional postcard combines two stiff printable papers and usually has a landscape picture on the front side and necessary mailing information on the back side. It can be directly sent after sticking a stamp.

A Chinese invention, patented 03267760.X, discloses a mag-postcard, including a decorated pattern layer and a flexible magnet layer, wherein the flexible magnet layer has magnet property to ensure the mag-postcard to stick on metal surface or any surface formed by metal material. However, simply added a magnet layer upon the conventional postcard, this invention has defects as follows:
(1) It is only acceptable indoors, such as home or office, and lack of mailing function. If user sends this mag-postcard as a normal postcard, the user has to separate the magnet layer from the convention card and then posts the separated conventional card. While the postcard reaches the destination, the receiver has to combine the separated conventional card with another magnet layer to achieve the original sticking function.
(2) The flexible magnet layer is only partly attached with a conventional postcard, which covers some mailing information to cause difficult reading and unattractive appearance.
(3) The mag-postcard will easily be bent or wrinkle after used for a long time since the postcard only partly sticks on the surface of desk or wall with the magmatic layer and part of the card is still separated from the touching surface.

### SUMMARY FOR THE INVENTION

The present invention introduces an integrated mag-postcard having advantages of simple structure, normal appearance as a conventional card, full magnetic effect, and easy to use.

In order to achieve above purposes, the present invention provides solutions as follows:

An integrated mag-postcard has a pattern layer, a magnet layer and a mailing information layer, wherein the magnet layer is located between the magnet layer and the mailing information layer, and wherein the magnet layer is attached tightly with other two layers.

The pattern layer is coated with a film layer formed by transparent film or an UV layer formed by transparent UV oil to protect the pattern layer.

The pattern layer is made from printable materials, such as paper, PVC, PET or non-woven fabrics, etc.

The pattern layer is substantially a printable coating attached with the magnet layer by coating, silk screen printing or spraying, etc.

The surface of the pattern layer can be printed with pictures, texts, etc. It is further left blank to allow users to design their personal cards as they like.

The magnet layer made of flexible magnet material is substantially a thin layer having magnetic property. The magnet layer is attached with the pattern layer by pasting or heat sealing. The magnet layer can also be made of magnetic powder and attached with the pattern layer by coating, silk screen printing or spraying. The function of the magnet layer is to ensure the postcard totally and freely stick on iron surface.

The thickness of the magnet layer is 0.0 8mm˜0.2 mm, which makes it nearly the same thickness as a conventional card.

The mailing information layer has necessary post information thereon, such as address column, zip code column and stamp area. The mailing information layer is made from printable materials, such as paper, PVC, PET or non-woven fabrics, etc, and attached with the magnet layer by pasting or heat sealing.

The mailing information layer is substantially a printable or writable coating attached with the magnet layer by coating, silk screen printing or spraying, etc.

The principle of the present invention is: an integrated magnetic postcard has a pattern layer, a magnet layer and a mailing information layer. The thickness of the magnetic postcard is the same as a conventional postcard due to these three layers integrated together properly and evenly. The middle magnet layer ensures the postcard stick easily on metal surface. Moreover, the magnetic attraction force of the magnet layer is between 20 G and 200 GS as low magnet. The low magnet feature assures the integrated magnetic postcard pass the examination of postal system or distribute facilities and be mailed successfully.

The present invention has advantages as follows:
(1) The integrated structure ensures the mag-postcard to stick freely on iron surface and easy to use.
(2) The integrated mag-postcard can be kept well for a long time without bending or wrinkle when it sticks on metal surface.
(3) The integrated mag-postcard has a common appearance without any subsidiary thereon as a conventional postcard and be readable as a normal postcard.
(4) The integrated mag-postcard can be sent normally as a conventional postcard and maintain its magnetic property at any place.

### BRIEF DESCRIPTION OF THE DRAWINGS

FIG. 1 is outline view of the integrated mag-postcard in accordance with the present invention.

FIG. 2 is sectional view of the integrated mag-postcard in accordance with the present invention.

FIG. 3 is a sectional view of another embodiment in accordance with the present invention.

### DETAILED DESCRIPTION

Many aspects of the invention should be better understand with reference to the following detailed description accompany with drawings. It should be noted that many variations and modifications may be made to the following embodiments of the invention without departing substantially from the spirit and principles of the invention.

### Embodiment 1

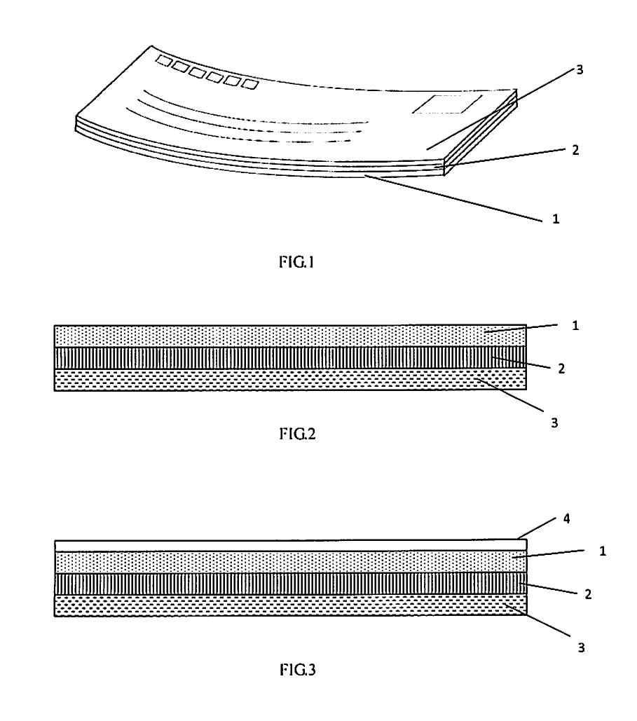

A specific structure is illustrated in FIG. 1 and FIG. 2. As shown in FIG. 1, an integrated magnetic postcard provided by the present invention has the same appearance as a conventional card. The front page is a pattern side for printing, such as pictures and texts. The back side is used for necessary mailing information, such as address column, zip code column, stamp area, etc.

As shown in FIG. 2, the integrated magnetic postcard has a pattern layer 1, a magnet layer 2 and a mailing information layer 3, wherein the magnet layer 2 is located between the pattern layer 1 and the mailing information layer 3, and wherein the magnet layer 2 is attached tightly with both the pattern layer 1 and the mailing information layer 3 by pasting or heat sealing. The pattern layer 1 and the mailing information layers 3 each are made from printable materials, such as paper, PVC, PET or non-woven fabrics. The magnet layer 2 made of flexible magnet material is substantially a thin layer having magnetic property, which is attached with both the pattern layer 1 and the mailing information 3 by pasting or heat sealing. In addition, the magnet layer 2 is further made of magnetic powder and attached with the pattern layer by coating, silk screen printing or spraying. The thickness of the magnet layer is 0.0 8mm˜0.2 mm.

### Embodiment 2

FIG. 3 shows the specific structure of another embodiment. Except the features mentioned in embodiment 1, the pattern layer 1 is further coated with a film layer 4 formed by transparent film or an UV layer formed by UV oil to protect the pattern layer 1 from damage.

### Embodiment 3

The features shown in this embodiment is nearly the same as those shown in embodiment 1, the exception is:

The pattern layer 1 is substantially a printable coating attached with the magnet layer 2 by coating, silk screen printing or spraying. The surface of the pattern layer 1 is preferred blank which allow users to print personal design at home or office to personalize postcard. The mailing information layer 3 is also a printable or writable coating attached with the magnet layer 2 by coating, silk screen printing or spraying. The surface of the mailing information layer 3 has necessary post information thereon, such as address column, zip code column and stamp area.

It should be emphasized that the above-described embodiments of the present invention, particularly, any “preferred” embodiments, are merely set forth for a clear understanding of the principles of the invention. Any changes, modifications, alternatives, combinations or simplifications are intended to be included herein within the scope of this disclosure and the present invention and protected by these claims.

1. An integrated magnetic postcard including a pattern layer, a magnet layer and a mailing information layer, wherein the magnet layer is located between the pattern layer and the mailing information layer, wherein the magnet layer is attached tightly with both the pattern layer and the mailing information layer.

2. The integrated magnetic postcard of claim 1, wherein the pattern layer is made from paper, PVC, PET or non-woven fabrics.

3. The integrated magnetic postcard of claim 1, wherein the pattern layer is substantially a printable coating attached with the magnet layer.

4. The integrated magnetic postcard of claim 1, wherein the pattern layer is coated with a film layer or an UV layer.

5. The integrated magnetic postcard of claim 1, wherein the surface of the pattern layer is blank.

6. The integrated magnetic postcard of claim 1, wherein the magnet layer formed by flexible magnet material is substantially a thin layer attached with the pattern layer by pasting or heat sealing.

7. The integrated magnetic postcard of claim 1, wherein the magnet layer is further made of magnetic powder material and attached with the pattern layer by coating, silk screen printing or spraying.

8. The integrated magnetic postcard of claim 1, wherein the thickness of the magnet layer is 0.08 mm to 0.2 mm.

9. The integrated magnetic postcard of claim 1, wherein the mailing information layer is made from paper, PVC, PET or non-woven fabrics and attached with the magnet layer by pasting or heat sealing.

10. The integrated magnetic postcard of claim 1, wherein the mailing information layer is substantially a writable coating attached with the magnet layer by coating, silk screen printing or spraying.

11. The integrated magnetic postcard of claim 2, wherein the pattern layer is coated with a film layer or an UV layer.

12. The integrated magnetic postcard of claim 3, wherein the pattern layer is coated with a film layer or an UV layer.

13. The integrated magnetic postcard of claim 6, wherein the thickness of the magnet layer is 0.08 mm to 0.2 mm.

14. The integrated magnetic postcard of claim 7, wherein the thickness of the magnet layer is 0.08 mm to 0.2 mm.
